(19) United States
(12) Patent Application Publication
(10) Pub. No.: US 2016/0090524 A1
(43) Pub. Date: Mar. 31, 2016

(54) ASPHALTENE INHIBITION

(71) Applicant: THE LUBRIZOL CORPORATION, Wickliffe, OH (US)

(72) Inventor: Antonio Mastrangelo, Alfreton, Derbyshire (GB)

(21) Appl. No.: 14/892,606

(22) PCT Filed: May 20, 2014
(86) PCT No.: PCT/US14/38702

§ 371 Date: Nov. 20, 2015

Related U.S. Application Data
(60) Provisional application No. 61/827,779, filed on May 28, 2013.

(51) Int. Cl. C09K 8/524

(52) U.S. Cl. CPC C09K 8/524

(57) ABSTRACT

The technology disclosed herein provides compositions and methods for asphaltene control in a hydrocarbon fluid, such as crude oil, by employing a thiophosphonate ester compound.

### BACKGROUND OF THE INVENTION

The technology disclosed herein provides a composition and method for asphaltene control in a hydrocarbon fluid, such as crude oil, by employing a thiophosphonate ester compound.

It is well known that hydrocarbon fluids, such as crude oil or residual oil, deposit asphaltenes during production and/or use. In the example of a crude oil, asphaltenes are maintained in a stable colloidal dispersion in the hydrocarbon fluid under the temperature, pressure, composition and environmental conditions found in the oil bearing reservoir. However, when the temperature or pressure are reduced e.g. during extraction from an oil reservoir, changes in composition (loss of gas and other light components) largely due to pressure and temperature changes enables asphaltene molecules to agglomerate or otherwise precipitate out to form asphaltene deposits. The asphaltene deposits are capable of causing occlusion and ultimately blockage within the oil bearing strata or anywhere else along the production and storage system through which the oil passes or is stored, including any pipe, conduit or storage vessel. The occlusion reduces production rates such that it becomes necessary to mechanically remove the deposits, resulting in loss of production, down-time and increased engineering costs.

In the case of asphaltenic residual and heavy fuels, the destabilization of the asphaltene colloid is generally due to similar reasons, but also due to the addition of cutter stocks or in-tank mixing of different and incompatible batches of fuel, which can result in a hydrocarbon environment which does not maintain the stability of the asphaltenes. An example of this often seen in practice is when ships change over to low sulphur fuel for entry into areas where the use of high sulphur fuels is prohibited. Changing over to low sulphur fuel can destabilize the asphaltene resulting in asphaltene deposition in pipework and possible blockage of filters, etc. Therefore it is important to efficiently disperse agglomerated asphaltenes in the bulk hydrocarbon, or to remove and/or inhibit the formation of asphaltene deposits to avoid blockage in a crude oil production system.

In the case of asphaltene deposition in refinery and other petrochemical plant applications, a hydrocarbon stream already containing asphaltenes can be formed in situ. In this case, the asphaltene deposition results in the formation of carbonaceous deposits in a process known as coking or fouling.

Therefore asphaltene deposits are known to be capable of causing blockage to a number of applications involving a hydrocarbon fluid and it is important to remove or inhibit the formation of asphaltene deposits to avoid blockage of an oil well or pipelines.

British Patent application GB 2,337,522 discloses a carboxylic polymer capable of reducing asphaltene deposition formed from at least one of (a) an ethylenically unsaturated alcohol, carboxylic acid or ester, (b) an ethylenically unsaturated carboxylic ester with a polar group in the ester, and (c) an ethylenically unsaturated carboxylic amide. A preferred polymer is a alkyl (meth) acrylate.

International Publication WO 01/055281 discloses an inhibitor for asphaltene deposition employing a compound selected from a polyhydric alcohol reacted with a carboxylic acid, an ester or ether formed from a glycidyl ether or epoxide.

It would be desirable to have a method of asphaltene control in a hydrocarbon fluid. The present technology provides methods of asphaltene control in a hydrocarbon fluid as well as asphaltene controlled compositions.

### SUMMARY OF THE INVENTION

There is provided a method of asphaltene control in a hydrocarbon fluid, the method employing a thiophosphonate ester polymer dispersant.

In one embodiment, the thiophosphonate ester composition can include the esterified product of a steam reformed reaction product of a polyolefin with phosphorus pentasulfide.

In an embodiment, the thiosphosphonate reaction product can comprise mixture of compounds including formula (I):

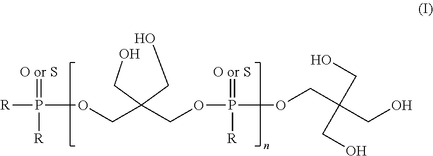

wherein

R is a polyolefin of from about 150 to about 5000 number average molecular weight.

In another embodiment of the thiophosphonate reaction product, the mixture can include compounds of formula (II) or (III):

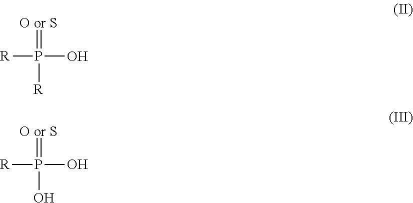

where R is as defined above.

In one embodiment the invention further provides a composition comprising:

(a) a hydrocarbon fluid;

(b) an optional oil of lubricating viscosity; and

(c) a thiophosphonate ester polymer dispersant.

### DETAILED DESCRIPTION OF THE INVENTION

There is provided a method of asphaltene control in a hydrocarbon fluid, the method comprising employing a composition comprising: a hydrocarbon fluid and an esterified product of a steam reformed reaction product of a polyolefin and phosphorus pentasulfide, including salts thereof.

### Hydrocarbon Fluid

The hydrocarbon fluid can be an oil, including aliphatic or liquid aromatic oils. The hydrocarbon fluid may be crude oil, black oil, or a non-volatile fraction from a distillation of a crude oil. The hydrocarbon fluid may also be a heavy fuel such as a heavy distillate heating oil or marine/industrial fuel oil, including bunker fuel. The hydrocarbon fluid may also be any petrochemical process oil which has a propensity to form asphaltenic and ultimately coke-like species at surfaces under high temperature conditions. In one embodiment the hydrocarbon fluid can be an oil field product, e.g. a whole well product or a multiphase mixture in or from a well bore, or one at a well head after at least partial separation of gas and/or water, for instance, an oil export fraction. In one embodiment the hydrocarbon fluid can be a refinery or petrochemical process stream or a heavy distillate or residual fuel.

The hydrocarbon may contain at least 0.01 wt % of asphaltene, in another embodiment up to 30 wt % of asphaltene based on the total weight of the hydrocarbon fluid. Examples of suitable ranges of asphaltene present in the hydrocarbon fluid include up to 90 wt % or 0.001 wt % to 90 wt %, 0.01 wt % to 70 wt % or 0.04 to 50 wt % or 0.06 to 30 wt %. In one embodiment the asphaltene content can be up to 90 wt %, based on the total weight of the hydrocarbon fluid. Generally oil shale, bitumen or asphalt hydrocarbon fluids contain higher levels of asphaltene.

The hydrocarbon fluid may further comprise wax, often present from 0 wt % to 35 wt %, 0.5 wt % to 30 wt % or 1 wt % to 15 wt %, based on the total weight of the hydrocarbon fluid; gas present from 0 wt % to 10 wt % or water (or water droplets) from 0 wt % to 20 wt %, based on the total weight of the hydrocarbon fluid. The hydrocarbon fluid in one embodiment has multiple phases between the oil and gas and/or water.

### Ester Compounds

The methods and composition include a thiophosphonate ester or salt composition, referred to herein as the thiophosphonate. The thiophosphonate can be a mixture of compounds resulting from performing an esterification, or simply forming a salt, of a steam reformed reaction product of a polyolefin with phosphorus pentasulfide.

The reaction of the polyolefin and phosphorus pentasulfide can generally be carried out from about 150 to about 300° C., or about 175 to about 275° C., or about 200 to about 250° C.

The polyolefins include homopolymers and interpolymers of polymerizable olefin monomers of 2 to about 16 or to about 6, or to about 4 carbon atoms. The olefins may be monoolefins such as ethylene, propylene, 1-butene, isobutene, pinene and 1-octene; or a polyolefinic monomer, such as a diolefinic monomer, such as 1,3-butadiene and isoprene. In one embodiment, the interpolymer is a homopolymer. An example of a polymer is a polybutene. In one instance about 50% of the polybutene is derived from isobutylene. The polyolefins are prepared by conventional procedures. The polyolefin can have a number average molecular weight (“Mn”) of from about 150 to about 5000, or from about 300 to about 4000, and in some cases from about 500 to about 3500, or from about 1000 to about 2000, or 2500 or 3000.

The polyolefin in general can have the structure of formula (I):

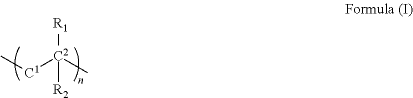

wherein,

R₁ and R₂ can separately be a straight chain, branched or cyclic alkyl of 1 to 6, 8, 10 or 12 carbons atoms, or can together can form a cyclic structure between each other, or together or separately can form a cyclic structure with the neighboring C¹ carbon atom, and

n is the average number of repeating units such that the polyolefin has an Mn as discussed immediately above.

Reformation of the reaction product mixture resulting from the reaction of the polyolefin and phosphorus pentasulfide can generally be carried out in steam for about 7 to about 8 hours.

The steam reformed product can be salted, for example, with barium, calcium, sodium, and the like.

In an alternate embodiment, the steam reformed product can be esterified in a solvent, such as, for example, mineral oil, or synthetic oil, such as polyalphaolefins, and the like, at a temperature from about 175 to about 275° C. Suitable reactants for the esterification include, for example, pentaerythritol, glycerol, sorbitol, 1,1,1-tris(hydroxymethyl)propane, and tris(hydroxymethyl)aminomethane.

In some embodiments, the thiophosphonate reaction product can contain a mixture of compounds. In some embodiments, the mixture can include compounds of formula (II) or (III), or salts thereof (e.g., barium, calcium, sodium, etc.):

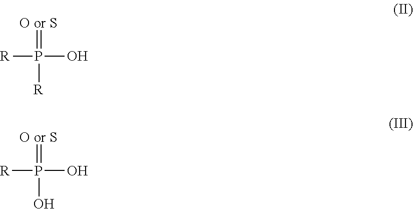

where R is a polyolefin having an Mn in the same range as the polyolefin, discussed above, for example, from about 150 to about 5000.

In one embodiment, an esterified product of the steam reformed reaction product of a polyolefin and phosphorus pentasulfide can comprise a mixture of compounds including a thiophosphonate ester of formula (I):

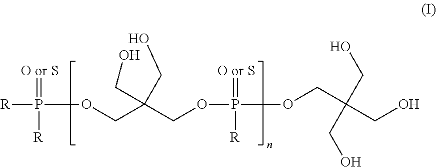

wherein R is as defined above.

### Oil of Lubricating Viscosity

The methods and compositions disclosed herein optionally can include an oil of lubricating viscosity, including natural or synthetic oils of lubricating viscosity, oil derived from hydrocracking, hydrogenation, hydrofinishing, unrefined, refined and re-refined oils, or mixtures thereof. In one embodiment the oil of lubricating viscosity is a carrier fluid for the dispersant and/or other performance additives.

Natural oils include animal oils, vegetable oils, mineral oils or mixtures thereof. Synthetic oils include a hydrocarbon oil, a silicon-based oil, a liquid ester of phosphorus-containing acid. Synthetic oils may be produced by Fischer-Tropsch reactions and typically may be hydroisomerised Fischer-Tropsch hydrocarbons or waxes.

Oils of lubricating viscosity may also be defined as specified in the American Petroleum Institute (API) Base Oil Interchangeability Guidelines. In one embodiment the oil of lubricating viscosity comprises an API Group I, II, III, IV, V or mixtures thereof, and in another embodiment API Group I, II, III or mixtures thereof. If the oil of lubricating viscosity is an API Group II, III, IV or V oil there may be up to about 40 wt % and in another embodiment up to about 5 wt % of the lubricating oil an API Group I oil.

### Other Performance Additive

Optionally the composition can further include at least one other performance additive. The other performance additive compounds include a metal deactivator, a detergent, an antiwear agent, an antioxidant, a corrosion inhibitor, a foam inhibitor, a demulsifiers, a pour point depressant, a seal swelling agent, one or more wax control polymers (including wax crystal modifiers and wax dispersants, such as ethylene vinyl acetate, fumarate vinyl acetate, copolymer esters or alkyl phenol resins), scale inhibitors including phosphate esters, gas-hydrate inhibitors (often known as freeze point depressant) including methanol or mixtures thereof.

The total combined amount of the other performance additive compounds present on an oil free basis in ranges from about 0 wt % to about 25 wt %, in another embodiment about 0.0005 wt % to about 25 wt %, in another embodiment about 0.001 wt % to about 20 wt % and in yet another embodiment about 0.002 wt % to about 15 wt % of the composition. Although one or more of the other performance additives may be present, it is common for the other performance additives to be present in different amounts relative to each other.

### Process

There is further provided a process for preparing a composition comprising the steps of mixing an oil of lubricating viscosity and a thiophosphonate ester to form a dilute composition or a concentrate.

The components may be mixed sequentially and/or separately to form the dilute composition or concentrate. The mixing conditions include for a period of time in the range about 30 seconds to about 48 hours, in another embodiment about 2 minutes to about 24 hours, in another embodiment about 5 minutes to about 16 hours and in yet another embodiment about 10 minutes to about 5 hours; and at pressures in the range including about 86 kPa to about 500 kPa (about 650 mm Hg to about 3750 mm Hg), in another embodiment about 86 kPa to about 266 kPa (about 650 mm Hg to about 2000 mm Hg), in another embodiment about 91 kPa to about 200 kPa (about 690 mm Hg to about 1500 mm Hg), and in yet another embodiment about 95 kPa to about 133 kPa (about 715 mm Hg to about 1000 mm Hg); and at a temperature including about 15° C. to about 70° C., and in another embodiment about 25° C. to about 70° C.

The process optionally includes mixing the other optional performance additives as described above. The optional performance additives may be added sequentially, separately or as a concentrate.

### INDUSTRIAL APPLICATION

The method and composition disclosed herein can be useful in the reduction and/or inhibition of asphaltene deposit formation and/or flocculation in a subterranean oil reservoir, oil pipe line or storage vessel or other relevant equipment with which a hydrocarbon fluid, e.g., a crude oil, may come in contact. The method and composition can also be useful in the reduction and/or inhibition of deposit formation and settling in industrial and marine hydrocarbon fuel systems, including where fuel stream mixing may occur and give rise to asphaltenic destabilization, agglomeration and settling or deposition. The method and composition can also be useful in the inhibition of deposition of asphaltenic species at surfaces in refinery and petrochemical processes.

The thiophosphonates described above may be added to the hydrocarbon fluid, for example, in an oil reservoir, pipe line, or storage vessel or other relevant equipment, at levels of about 1 ppm to 30 wt % relative to the amount of hydrocarbon fluid present, in another embodiment 5 ppm to 10 wt %, in another embodiment 20 ppm to 3 wt % and in another embodiment 40 ppm to 1 wt %. For example the dispersant can be present in a hydrocarbon fluid from about 60 ppm to about 500 ppm or about 80 ppm to about 350 ppm relative to the amount of the hydrocarbon fluid present.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

substituted hydrocarbon substituents, that is, substituents containing non-hydrocarbon groups which, in the context of this disclosure, do not alter the predominantly hydrocarbon nature of the substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this disclosure, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the composition disclosed herein encompasses the composition prepared by admixing the components described above.

The technology herein can be useful for asphaltene control, which may be better understood with reference to the following examples.

The following examples provide an illustration of various aspects of the invention. These examples are non exhaustive and are not intended to limit the scope of the invention.

### EXAMPLES

### Preparative Sample 1

A 1000 Mn polyisobutylene (944 parts by weight “pbw”) and phosphorus pentasulfide (85 pbw) were charged to a jacketed reaction vessel fitted with a stirrer, condenser, addition funnel inlet, a nitrogen line and thermocouple with temperature controller system. After mixing for 30 minutes under a nitrogen blanket, the reaction vessel was heated to 260° C. (260-266° C.) and held for 7 hours. The vessel was then cooled to 152° C. (149-161° C.) and steam (38.9 pbw) blown for a further 7 hours (8 hours max), when the acid number was approximately 35, to give a mixture of phosphonic, phosphinic, thiophosphonic and thiophosphinic acids. Diluent oil (929.955PBW) and pentaerythritol (143.9 pbw) were then charged to the vessel and the temperature adjusted to 224° C. (221-227° C.) and sparged with nitrogen until the acid number was less than 10. The batch was then cooled to 99° C. (93-105° C.) and filtered to give a clear product, which was a mixture of esters containing about 1% phosphorous, about 0.73% sulphur, and a viscosity of around 54 cSt at 100° C.

### Preparative Example 2

The same process as preparative example 1 is used, replacing the 1000 Mn polyisobutylene with a 2300 Mn polyisobutylene.

### Preparative Example 3

The same process as preparative example 1 is used, replacing the 1000 Mn polyisobutylene with a 250 Mn polyisobutylene.

### Preparative Example 4

The same process as preparative example 1 is used, replacing the 1000 Mn polyisobutylene with a C₂₀₋₂₂ alpha olefin of around 300 Mn under the trade name Neodene™ 2022, available from Shell Chemicals.

### Comparative Samples 1-3

Comparative samples 1-3 are commercial asphaltene inhibitors, 1) a Polyolefin ester under the trade name Lubrizol® 5948, available from Lubrizol, 2) a Polyolefin amide alkeneamine under the trade name Lubrizol® 5938C, available from Lubrizol, and 3) a Novolak, under the trade name FloZol® 2252H, available from Lubrizol.

### Comparative Sample 4

Comparative sample 4 is a phosphonic acid as prepared in U.S. Publication No. 2011/0098507 to Cohrs, et al., published Apr. 28, 2011, Saponification Example 8 (precursor made as described for Free-Radical Addition Example 1).

### Example 1

### Optical Settling Rate Measurement Test

The light turbidity test is used to determine the rate of flocculation and/or settling of an asphaltene dispersion, i.e. the point where the asphaltene is no longer stabilized in oil, and its rate of settling following the introduction into the test oil a sample asphaltene dispersant. The test employs filling a measurement cell of a Turbiscan® MA 2000 liquid dispersion optical characterization apparatus with a test oil and flocculant (e.g. hexane, heptane), and scanning 70 mm deep into the test oil in order to periodically measure the progression of the asphaltene settling front. The change in light transmittance (relative to time zero) relayed by the scanning apparatus can be expressed as a percentage change in the average light transmission (relative to time zero) through the sample over the 70 mm scanned depth, from a light source having a wavelength of 850 nm. The stability of the asphaltenic dispersion in the oil is determined by measuring the average percentage change in light transmitted on the addition of the sample asphaltene dispersant at regular intervals over a specified test period.

In order to compare different oils and asphaltene dispersants with different responses in the percent change in light transmission, the percent change in light transmission data can be restated in terms of percent asphaltene dispersion. The percent asphaltene dispersion can be calculated by the following equation:

% Asphaltene Dispersion=[(TC_{blank}−TC_{chemical})/TC_{blank}]×100

where,

TC_{blank} is the change in light transmission for an untreated oil

TC_{chemical} is the change in light transmission for the treated oil

Generally samples with a higher % Asphaltene Dispersion have more stable asphaltene dispersions than samples with lower % Asphaltene Dispersion.

The preparative and comparative samples were tested in four different crude oils at two concentrations of 50 and 200 ppm. The four different crude oils each had a different level of asphalt content by weight, and therefore a different baseline % light transmission. Generally, oils with lower % change in transmission over the course of the test are considered more stable Oil 1 had an asphalt content of about 0.46% and a % light transmission of 29.4, Oil 2 had an asphalt content of about 1.70% and a % light transmission of 41.3, Oil 3 had an asphalt content of about 2.44% and a % light transmission of 38.3, and Oil 4 had an asphalt content of about 6.77% and a % light transmission of 45.3.

The calculated % Asphaltene Dispersion for each Sample tested is shown in Table 1.

TABLE 1

| | Oil 1 | | Oil 2 | | Oil 3 | | Oil 4 | |
|---|---|---|---|---|---|---|---|---|
| | Sample treat rate (ppm) | | | | | | | |
| | 50 | 200 | 50 | 200 | 50 | 200 | 50 | 200 |
| Crude Injection | 500 | 500 | 400 | 400 | 200 | 200 | 100 | 100 |
| Amount (μL) | | | | | | | | |
| Measurement | 30 | 30 | 20 | 20 | 20 | 20 | 20 | 20 |
| Time (min) | | | | | | | | |
| Preparative | 0.0 | 91.7 | 49.9 | 100.0 | 0.2 | 59.7 | 20.9 | 99.9 |
| Sample 1 | | | | | | | | |
| Comparative | 96.1 | 97.0 | 100.0 | 100.0 | 83.8 | 100.0 | 8.9 | 86.6 |
| Sample 1 | | | | | | | | |
| Comparative | 0.0 | 94.4 | 100.0 | 100.0 | 56.7 | 100.0 | 6.1 | 50.1 |
| Sample 2 | | | | | | | | |
| Comparative | 0.0 | 94.0 | 0.0 | 2.6 | 4.5 | 14.8 | 3.7 | 40.4 |
| Sample 3 | | | | | | | | |
| Comparative | 0.0 | 1.3 | 0.0 | 19.2 | 18.1 | 25.7 | 0.3 | 68.0 |
| Sample 4 | | | | | | | | |

Overall the analysis indicates that the method and composition disclosed herein can provide a reduction and/or inhibition of asphaltene flocculation and/or deposit formation in a subterranean oil reservoir, oil pipe line or storage vessel or other relevant equipment a hydrocarbon fluid may come in contact with.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A method of asphaltene control in an oil field product, comprising employing a thiophosphonate ester composition comprising: an esterified product of a steam reformed reaction product of a polyolefin and phosphorus pentasulfide.

2. The method of claim 1, wherein the polyolefin has a number average molecular weight of from about 150 to about 5000.

3. The method of claim 1, wherein the esterified product of the steam reformed reaction product includes at least one of formula (I), (II), (III), 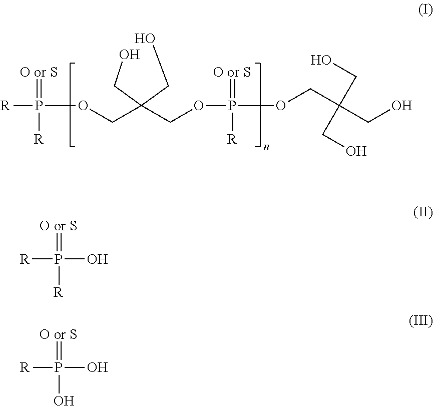
and combinations thereof,
wherein
R is the polyolefin and has a number average molecular weight of from about 150 to about 5000.

4. The method of claim 1, wherein the polyolefin is polyisobutylene.

5. The method of claim 1, wherein the hydrocarbon fluid has an asphaltene content of at least 0.01 wt %.

6. The method of claim 1, wherein the hydrocarbon fluid has an asphaltene content of up to a maximum of 90 wt %.

7. (canceled)

8. A composition comprising:
a. a crude oil; and
b. a thiophosphonate ester polymer dispersant,
wherein the thiophosphonate ester polymer dispersant comprises an esterified product of a steam reformed reaction product of a polyolefin and phosphorus pentasulfide.

9.-11. (canceled)
